(19) United States
(12) Patent Application Publication
(10) Pub. No.: US 2005/0223744 A1
(43) Pub. Date: Oct. 13, 2005

(54) Glass substrate for data recording medium and manufacturing method thereof

(76) Inventors: Tamaki Horisaka, Osaka (JP); Kazuya Fujino, Osaka (JP); Kensuke Matsuno, Osaka (JP); Eiji Okuda, Osaka (JP)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/149,510

(22) Filed: Jun. 10, 2005

Related U.S. Application Data
(62) Division of application No. 10/281,495, filed on Oct. 28, 2002.

(30) Foreign Application Priority Data
Nov. 21, 2001 (JP) 2001-356468

(51) Int. Cl. B32B 3/02; C03B 29/00

(52) U.S. Cl. 65/61; 428/66.6; 65/65

(57) ABSTRACT

A glass substrate for a data recording medium is disk-shaped and has a circular bore at the center portion. At least one of an inner circumferential end surface and an outer circumferential end surface is smooth. The smooth surface is formed by exposing at least one of the inner circumferential end surface and the outer circumferential end surface of a glass disk to a laser beam. During laser machining, the end surface of the glass disk that is exposed to the laser beam is heated and melted. Therefore, minute cracks, formed on the end surface of the glass disk before the laser machining, are eliminated. As a result, the strength of the glass substrate is maintained without a chemical strengthening treatment. This eliminates disadvantages caused by the chemical strengthening step.

### BACKGROUND OF THE INVENTION

The present invention relates to a glass substrate for a data recording medium of a data recording apparatus such as a hard disk and to a manufacturing method of the glass substrate. More specifically, the present invention pertains to a glass substrate for a data recording medium that maintains strength without performing a chemical strengthening treatment on the glass substrate and eliminates disadvantages caused by a chemical strengthening treatment, and to a manufacturing method of the glass substrate.

A typical glass substrate for a data recording medium, such as a magnetic disk, a magnetic optical disk, and an optical disk, has a magnetic film formed on the front surface.

The conventional glass substrate is manufactured by a manufacturing process including a disk machining step, an end surface chamfering step, an end surface polishing step, a lapping step, a first polishing step, a second polishing step, a chemical strengthening step, and a washing step.

In the disk machining step, a sheet of glass is cut with a wheel cutter into a disk-shape and a bore is formed at the center.

In the end surface chamfering step, the inner circumferential end surface and the outer circumferential end surface of the glass disk are ground and chamfered with a diamond grind wheel. The outer diameter and the inner diameter of the glass disk are adjusted to predetermined dimensions.

In the end surface polishing step, the inner circumferential end surface and the outer circumferential end surface of the glass disk are ground with a rotating brush while being supplied with cerium oxide slurry so that the end surfaces become smooth.

In the lapping step, the surface of the glass disk is ground with slurry of alumina grain to adjust the thickness of the glass disk.

In the first polishing step, the surface of the glass disk is polished with a pad soaked in slurry of polishing agent. In the second polishing step, the surface of the glass disk is polished with a pad soaked in slurry of polishing agent that has smaller grain diameter than that used in the first polishing step.

In the chemical strengthening step, the glass disk is reinforced to be usable as a glass substrate for a data recording medium. More specifically, the glass disk is submerged in a molten salt bath consisting of, for example, potassium nitrate and sodium nitrate. At this time, monovalent metal ion, such as lithium and sodium, included in the composition of the glass disk is replaced with monovalent metal ion having greater ion radius such as potassium. This applies compressive stress to the surface of the glass disk, which strengthens the surface, particularly the end surface, of the glass disk.

In the washing step, molten salt adhered to the glass disk during the chemical strengthening step is washed away with warm water.

During the disk machining step and the end surface chamfering step, minute cracks 42 having the depth of 1 to 60 μm as shown by a chain double-dashed line in FIG. 7 are formed on the inner circumferential end surface and the outer circumferential end surface of the glass disk 41. When the end surface is polished in the end surface polishing step, the shallow minute cracks 42a are eliminated, but the deep minute cracks 42b having the depth of 20 μm or more remain on the end surface of the glass disk 41. If the end surface is polished until the deep minute cracks 42b are eliminated, the dimensional accuracy of the glass disk 41 deteriorates. Thus, not all the minute cracks 42 are eliminated in the end surface polishing step.

The glass disk 41 that has the minute cracks 42 remaining on the end surface lacks strength and might not endure the high speed rotation when used as a glass substrate for a data recording medium. The chemical strengthening step is performed to obtain enough strength to be usable as a glass substrate for a data recording medium even when the glass disk has minute cracks 42 remaining on the end surface.

However, the glass substrate for a data recording medium is adversely affected by the chemical strengthening step. More specifically, the potassium nitrate used in the chemical strengthening step generates a trace of potassium nitrite by thermal decomposition. The potassium nitrite erodes the front surface of the glass disk and increases the surface roughness of the front surface. Also, foreign objects, such as the polishing agent, minute particles of dust, and metal grains from devices performing the steps, might adhere to the surface of the glass disk before the chemical strengthening step. When the chemical strengthening step is performed on the glass disk to which foreign objects are adhered, minute pits are formed on the surface of the glass disk. Therefore, the smoothness of the surface of the glass disk is not maintained. Further, during the chemical strengthening step, chips and cracks might be formed on the glass disk while handling the glass disk. Further, the chemical strengthening step is a treatment that uses an ion-exchange reaction performed at a temperature near the glass transition point. Therefore, the glass disk can cause thermal deformation, which decreases the flatness.

In addition, although the end surface polishing step is performed, minute cracks still remain on the end surfaces of the glass disk. Thus, polishing agent, minute particles of dust, and foreign objects generated from devices performing the steps that are particularly less than or equal to 1 μm can enter the minute cracks in each step. The foreign objects that have entered the minute cracks are brought into subsequent steps with the glass disk. Foreign objects that come out of the minute cracks in the subsequent steps contaminate the subsequent steps and damage the surface of the glass disk.

### BRIEF SUMMARY OF THE INVENTION

Accordingly, it is an objective of the present invention to provide a glass substrate for a data recording medium that maintains strength without performing a chemical strengthening treatment on the glass substrate and eliminates disadvantages caused by a chemical strengthening treatment.

Another objective of the present invention is to provide a glass substrate for a data recording medium that is manufactured through a simplified procedure.

Further objective of the present invention is to provide a glass substrate for a data recording medium that eliminates the disadvantages caused by an end surface polishing step.

To achieve the above objective, the present invention provides a glass substrate for a data recording medium. The glass substrate is disk-shaped having a center portion and has a circular bore at the center portion. The glass substrate has an inner circumferential end surface and an outer circumferential end surface. At least one of the inner circumferential end surface and the outer circumferential end surface is substantially minute-crack free.

The present invention also provides a method for manufacturing a glass substrate for a data recording medium. The method includes: disk machining a sheet of glass to form a glass disk having a center portion and having a circular bore at said center portion, wherein the glass disk has an inner circumferential end surface and an outer circumferential end surface; and laser machining at least one of the inner circumferential end surface and the outer circumferential end surface of the glass disk by exposing said end surface to a laser beam, thereby heating and melting said end surface such that it becomes substantially minute-crack free.

A further aspect of the present invention is a method for manufacturing a glass substrate for a data recording medium. The method includes: disk machining a sheet of glass to form a glass disk having a center portion, having a circular bore at said center portion, and having a front surface, wherein the glass disk has an inner circumferential end surface and an outer circumferential end surface; grinding and chamfering at least one of the inner circumferential end surface and the outer circumferential end surface of the glass disk to produce at least one ground and chamfered end surface; laser machining at least one of the ground and chamfered end surfaces by exposing said end surface to a laser beam, thereby heating and melting said end surface such that it becomes substantially minute-crack free; polishing the front surface of the glass disk to make said front surface smooth; and washing the glass disk.

Other aspects and advantages of the invention will become apparent from the following description, taken in conjunction with the accompanying drawings, illustrating by way of example the principles of the invention.

### BRIEF DESCRIPTION OF THE SEVERAL VIEWS OF THE DRAWINGS

The invention, together with objects and advantages thereof, may best be understood by reference to the following description of the presently preferred embodiments together with the accompanying drawings in which:

FIG. 1 is a flowchart showing a manufacturing method of a glass substrate according to a first embodiment of the present invention;

FIGS. 2(a) and 2(b) are a plan view and a cross-sectional view illustrating a glass substrate or a glass disk, respectively;

FIG. 3 is an enlarged partial cross-sectional view illustrating an end surface of the glass disk;

FIG. 4 is an enlarged partial cross-sectional view illustrating minute cracks formed on the end surface of the glass disk;

FIG. 5 is an enlarged partial cross-sectional view illustrating a smooth surface formed on the end surface of the glass disk;

FIG. 6 is a partial cross-sectional view illustrating a laser irradiation equipment; and

FIG. 7 is an enlarged partial cross-sectional view illustrating an end surface of a prior art glass disk.

### DETAILED DESCRIPTION OF THE PREFERRED EMBODIMENTS

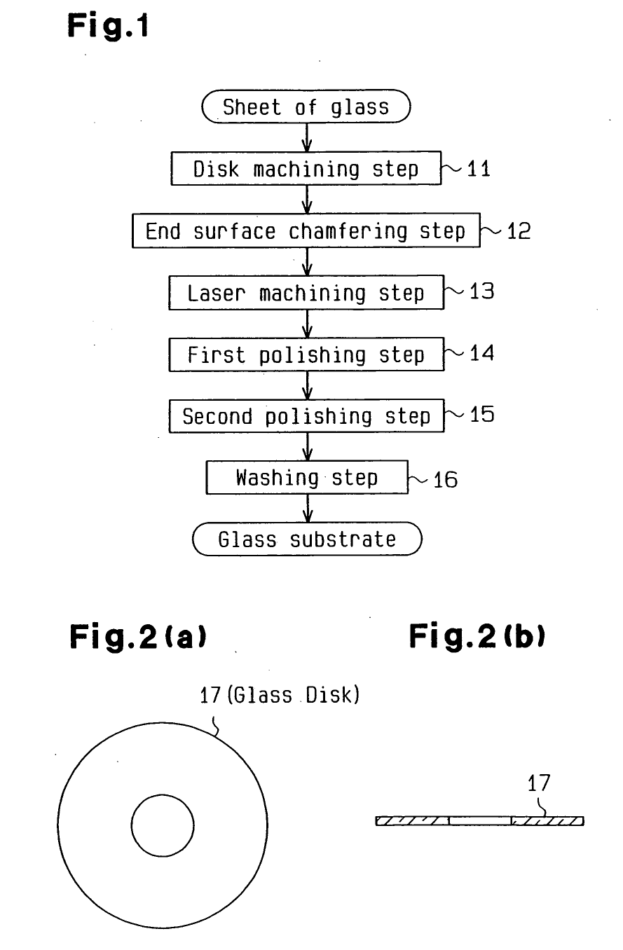

A preferred embodiment of the present invention will now be described with reference to FIGS. 1 to 6.

As shown in FIG. 1, a glass substrate of the present invention is manufactured by a process including a disk machining step 11, an end surface chamfering step 12, a laser machining step 13, a first polishing step 14, a second polishing step 15, and a washing step 16.

As shown in FIGS. 2(a) and 2(b) a sheet of glass is formed into a disk-like shape having a circular bore at the center portion to form a glass disk 17. For example, the outer diameter of the glass disk 17 is 84 mm and the inner diameter of the glass disk 17 is 25 mm The glass disk 17 is formed by cutting a sheet of glass having the thickness of 1.0 mm using a wheel cutter made of carbide alloy or diamond in the disk machining step 11. The glass disk 17 is made of, for example, soda lime glass, alminosilicate glass, borosilicate glass, and crystallized glass. These glasses are manufactured by a float process, a down draw process, a redraw process, or a press process.

After the disk machining step 11, the inner circumferential end surface and the outer circumferential end surface of the glass disk 17 have minute cracks 18 due to impacts during machining (see FIG. 4). The depth of the minute cracks 18 is greater than or equal to approximately 20 μm.

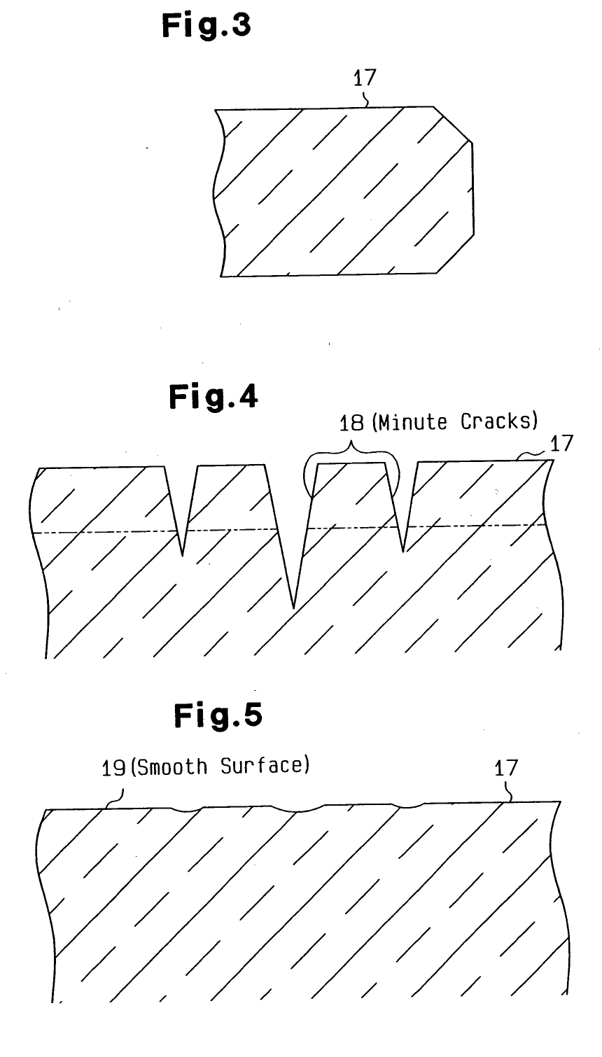

The end surface chamfering step 12 is performed on the glass disk 17, which is formed into a disk-like shape. In this step, the inner circumferential end surface and the outer circumferential end surface of the glass disk 17 are ground to adjust the outer diameter and the inner diameter of the glass disk 17. The grinding step includes, for example, two grinding steps. That is, in the first grinding step, the glass disk 17 is ground with a grind rock #324, which is rough, and in the second grinding step, the glass disk 17 is ground with a grind rock #500, which is smooth. The grind rocks are made of diamond in this embodiment. In the grinding steps, the edges of the inner circumferential end surface and the outer circumferential end surface are polished and the edges are chamfered at approximately 45 degrees as shown in FIG. 3.

During the end surface chamfering step 12, the end surfaces are ground to the level shown by a chain-double dashed line in FIG. 4. Thus, the minute cracks 18 formed by the disk machining step 11 become shallow. The impact of grinding might form new minute cracks 18 on the end surfaces. Therefore, the minute cracks 18 remain on the end surfaces of the glass disk 17 after the end surface chamfering step 12.

Subsequently, the inner circumferential end surface and the outer circumferential end surface of the glass disk 17 go through the laser machining step 13. The entire glass disk 17 or part of the glass disk 17 is preheated to a temperature lower than or equal to the softening point by a resistance heater. The end surfaces of the glass disk 17 are then exposed to a laser beam. The types of laser beam used in this step include, but not limited to, a carbon dioxide laser and a YAG laser. In view of the absorptivity of glass, the carbon dioxide laser is preferably used. The glass has high absorptivity for the laser beam having the dominant wavelength of preferably 250 nm to 20 μm and more preferably 900 nm to 12 μm. The energy density of the laser beam is preferably between 1 to 20 W/mm² and more preferably 1 to 10 W/mm². If the energy density is less than 1 W/mm², the temperature of the glass disk 17 cannot be increased sufficiently. On the other hand, if the energy density exceeds 20 W/mm², the melting rate of the glass disk 17 cannot be further improved.

When the end surfaces of the glass disk 17 are exposed to the laser beam, the end surfaces are heated to the temperature greater than or equal to the softening point of glass and melted. In this case, since the entire or part of the glass disk 17 is preheated to a predetermined temperature, a temperature difference is prevented from being caused between the end surfaces of the glass disk 17 and the middle portion between the end surfaces. The melted glass on the end surfaces then starts to flow, and the minute cracks 18 formed in the former step are gradually bonded by the melted glass. This eliminates the minute cracks 18 from the end surfaces as shown in FIG. 5. When the laser beam is stopped, the melted glass solidifies by thermal diffusion. As a result, the end surfaces have smooth surfaces 19 as shown in FIG. 5. That is the end surfaces are substantially minute crack-free. By “substantially minute crack-free,” we mean that there are only a few, if any, minute cracks and that any minute cracks that do exist are shallow.

The first polishing step 14 is performed on the front surface of the glass disk 17 to smooth the front surface. The front surface refers to the surface to which data is recorded when the glass disk 17 is used as a glass substrate for a data recording medium. The first polishing step 14 uses slurry that contains water and polishing agent, which is dispersed in the water such that the density of the polishing agent is 20% by weight. The polishing agent mainly contains cerium oxide and lanthanum oxide. The average grain diameter of the polishing agent is approximately 3 μm. The surface of the glass disk 17 is polished by a scouring pad made of urethane foam resin soaked in the slurry of the polishing agent. At this time, the end surfaces of the glass disk 17 have smooth surfaces 19 and have no minute cracks 18. Therefore, foreign objects, such as the polishing agent, minute particles of dust, and metal grains from devices performing the steps that are less than or equal to 1 μm, are prevented from entering the minute cracks 18.

The second polishing step 15 is performed on the front surface of the glass disk 17 to form the smooth surface that is required when the glass disk 17 is used as a data recording medium. The second polishing step 15 is performed using slurry that contains polishing agent having a smaller grain diameter than the polishing agent used in the first polishing step 14 and a scouring pad made of material such as suede.

The washing step 16 is performed to remove minute particles such as polishing agent and dust that are adhered to the glass disk 17. The washing step 16 is performed using cleaning fluid, such as water, surface-active agent, organic solvent, aqueous acids, and alkaline aqueous solution, and a scouring pad made of material such as suede. Then, the glass disk 17 is dried to form a glass substrate. For example, forming a foundation layer, a magnetic body, a protective layer, and a lubricating layer on the surface of the glass substrate in this order applies magnetic property to the surface, which produces a data recording medium such as a magnetic disk and a magnetic optical disk.

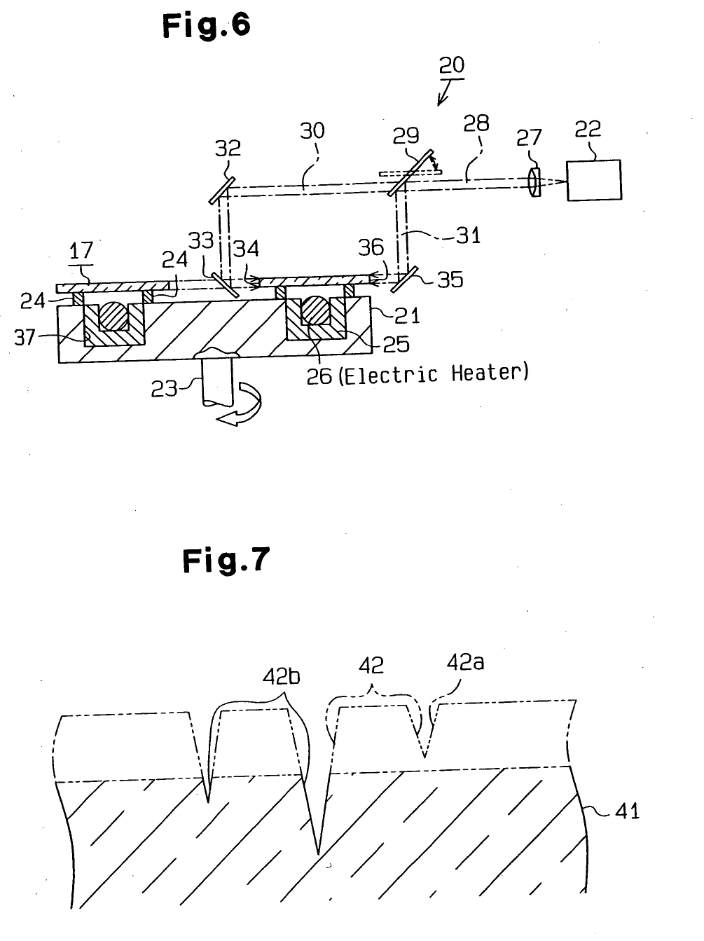

A laser irradiation equipment 20 used in the laser machining step 13 will now be described. As shown in FIG. 6, the laser irradiation equipment 20 includes a work table 21 and a laser oscillator 22, which emits a laser beam toward the work table 21.

The work table 21 is disk-shaped. A vertical shaft 23 is coupled to the center of the lower surface of the work table 21. The vertical shaft 23 is coupled to a motor, which is not shown, and is rotated by the motor. Rotation of the vertical shaft 23 rotates the work table 21. A pair of annular seats 24 is secured to the upper surface of the work table 21. The glass disk 17 is selectively located on the upper surface of the annular seats 24. An annular groove 37 is formed on the upper surface of the work table 21. A heat insulator 25 is arranged inside the annular groove 37. A resistance heater, which is an electric heater 26 in this embodiment, is located in the heat insulator 25. The electric heater 26 preheats the entire or part of the glass disk 17 located on the annular seats 24.

The laser oscillator 22 is located in the vicinity of the work table 21. A collimator 27 is located in a direction toward which a laser beam is emitted from the laser oscillator 22. The collimator 27 adjusts the direction of the emitted laser beam and converts the beam to laser beams 28, which are parallel to each other. The laser beams 28 are divided into a horizontal laser beam 30 and a vertical laser beam 31, which is directed downward, by a scan mirror 29. The inner circumferential end surface 34 of the glass disk 17 is exposed to the horizontal laser beam 30 with static mirrors 32, 33. The outer circumferential end surface 36 of the glass disk 17 is exposed to the vertical laser beam 31 with a static mirror 35.

The rotational speed of the work table 21 is set such that the peripheral velocity of the inner circumferential end surface 34 of the glass disk 17 is 0.02 to 5.0 mm/min. If the peripheral velocity is less than 0.02 mm/min., the tact time per one glass disk 17, or the time required for the end surface to melt from when the end surface is exposed to the laser beam, increases. On the other hand, if the peripheral velocity exceeds 5.0 mm/min., the glass disk 17 becomes unstable. In this case, accurate irradiation of the laser beams 30, 31 on the end surfaces 34, 36 of the glass disk 17 becomes difficult.

To perform the laser machining step 13 on the glass disk 17, the glass disk 17 to which the minute cracks 18 are formed on the end surfaces 34, 36 during the disk machining step 11 or the end surface chamfering step 12 is located on the annular seats 24 of the work table 21. The glass disk 17 is then rotated by the vertical shaft 23 and the entire or part of the glass disk 17 is preheated to the predetermined temperature by the electric heater 26. The laser beam emitted from the laser oscillator 22 is irradiated on the inner circumferential end surface 34 and the outer circumferential end surface 36 of the glass disk 17 via the collimator 27, the scan mirror 29, and the static mirrors 32, 33, and 35. Since the laser beam has high directivity, the laser beams 30, 31 are accurately irradiated on the end surfaces 34, 36 of the glass disk 17, respectively. When the laser beams 30, 31 are irradiated, the minute cracks 18 on the end surfaces 34, 36 are gradually bonded by melted glass and the minute cracks 18 are eliminated. When the glass disk 17 is rotated and the laser beams 30, 31 are not irradiated on the end surfaces 34, 36, the melted glass solidifies by thermal diffusion and the smooth surfaces 19 are formed. When the glass disk 17 rotates 360 degrees, the smooth surfaces 19 are formed along the entire end surfaces 34, 36. Thus, the end surfaces 34, 36 of the glass disk 17 are minute crack-free. This prevents the glass disk 17 from being damaged due to the minute cracks 18 when external force is applied to the glass disk 17 in the bending direction.

The advantages of the above embodiment are as follows.

The glass substrate for a data recording medium includes the smooth surface 19 formed by the laser machining step 13 on at least one of the end surfaces 34, 36. The smooth surface 19 do not have the minute cracks 18 formed during the disk machining step 11 and the end surface chamfering step 12. Therefore, the strength of the end surfaces 34, 36 is maintained. As described above, substantially all the minute cracks 18 on the end surfaces 34, 36 are eliminated by the laser machining step 13. However, some of the minute cracks 18 might remain within the range of manufacturing tolerance. In this case also, the deep and sharp cracks become shallow and smooth hollows that have curvatures. This solves the problem caused by the minute cracks 18. Therefore, the strength of the end surfaces 34, 36 is maintained.

According to the preferred embodiment, a chemical strengthening step is omitted. Therefore, disadvantages caused by the chemical strengthening step are resolved.

According to the preferred embodiment, an end surface polishing step and a lapping step are omitted. This reduces manufacturing steps and simplifies manufacturing of the glass substrate. This also eliminates the disadvantages caused by the end surface polishing step.

According to the preferred embodiment, the smooth surfaces 19 are formed by irradiation of the laser beams. Since the laser beam has high directivity, the laser beams 30, 31 are accurately irradiated on the end surfaces 34, 36 of the glass disk 17, respectively. Therefore, the end surfaces 34, 36 of the glass disk 17 are easily heated and melted, and the smooth surfaces 19 are easily formed.

The smooth surfaces 19 are formed on both the inner circumferential end surface 34 and the outer circumferential end surface 36. Since both the end surfaces 34, 36 are minute-crack free, the strength of the glass substrate is reliably guaranteed.

The entire or part of the glass disk 17 is preheated by the electric heater 26 before or during the laser machining step 13. This shortens the tact time of the glass disk 17. This also prevents the temperature difference from being caused between the end surfaces of the glass disk 17 and the middle portion between the end surfaces. Therefore, the deformation is prevented from being caused on the glass substrate.

It should be apparent to those skilled in the art that the present invention may be embodied in many other specific forms without departing from the spirit or scope of the invention. Particularly, it should be understood that the invention may be embodied in the following forms.

To reduce variation in thickness of the sheet of glass to which the disk machining step 11 is performed and increase the flatness, the sheet of glass may go through a lapping step as a preprocessing of the first polishing step 14. The required level of surface-roughness of the glass disk 17 is achieved by adding the lapping step. In the lapping step, #1000 or #1200 of alumina grains are used as the polishing agent and slurry that contains water and the polishing agent, which is dispersed in the water such that the density of the polishing agent is approximately 20% by weight is used.

If the dimensional accuracy of the glass disk 17 is reliably obtained in the disk machining step 11, the end surface chamfering step 12 may be omitted.

A washing step for washing the end surfaces of the glass disk 17 may be performed before the laser machining step 13. In this case, the end surfaces of the glass disk 17 are clean. Therefore, in the laser machining step 13, the smooth surfaces 19 are made even smoother.

Instead of exposing the end surfaces of the glass disk 17 to the laser beams, the glass disk 17 may be heated to the vicinity of the softening point. The end surfaces may then be exposed to a flame burner to bury the minute cracks 18 on the end surfaces, thereby forming the smooth surface 19.

Therefore, the present examples and embodiments are to be considered as illustrative and not restrictive and the invention is not to be limited to the details given herein, but may be modified within the scope and equivalence of the appended claims.

1-5. (canceled)

6. A method for manufacturing a glass substrate for a data recording medium, the method comprising:
disk machining a sheet of glass to form a glass disk having a center portion and having a circular bore at said center portion, wherein the glass disk has an inner circumferential end surface and an outer circumferential end surface; and
laser machining at least one of the inner circumferential end surface and the outer circumferential end surface of the glass disk by exposing said end surface to a laser beam, thereby heating and melting said end surface such that it becomes substantially minute-crack free.

7. The method according to claim 6, wherein the end surface that is exposed to the laser beam is made smooth by said laser machining step.

8. The method according to claim 6, wherein both of the inner circumferential end surface and the outer circumferential end surface are heated and melted in the laser machining step.

9. The method according to claim 6, wherein the entire or part of the glass disk is preheated by a resistance heater before or during the laser machining step.

10. The method according to claim 6, further comprising grinding both end surfaces of the glass disk.

11. The method according to claim 10, further comprising chamfering both end surfaces of the glass disk.

12. The method according to claim 6, wherein the laser beam is a carbon dioxide laser beam.

13. The method according to claim 6, further comprising, prior to the laser machining step, washing all end surfaces of the glass disk that are to be exposed to the laser beam.

14. A method for manufacturing a glass substrate for a data recording medium, the method comprising:
disk machining a sheet of glass to form a glass disk having a center portion, having a circular bore at said center portion, and having a front surface, wherein the glass disk has an inner circumferential end surface and an outer circumferential end surface;
grinding and chamfering at least one of the inner circumferential end surface and the outer circumferential end surface of the glass disk to produce at least one ground and chamfered end surface;
laser machining at least one of the ground and chamfered end surfaces by exposing said end surface to a laser beam, thereby heating and melting said end surface such that it becomes substantially minute-crack free;
polishing the front surface of the glass disk to make said front surface smooth; and
washing the glass disk.

15. The method according to claim 14, wherein the end surface that is exposed to the laser beam is made smooth by said laser machining step.

16. The method according to claim 14, wherein both of the inner circumferential end surface and the outer circumferential end surface are heated and melted in the laser machining step.

17. The method according to claim 14, wherein the entire or part of the glass disk is preheated by a resistance heater before or during the laser machining step.

18. The method according to claim 14, wherein the laser beam is a carbon dioxide laser beam.

19. The method according to claim 14, further comprising, prior to the laser machining step, washing the end surface of the glass disk that is to be exposed to the laser beam.

20. The method according to claim 14, further comprising, prior to the polishing step, lapping the front surface of the glass disk.
